(19) United States
(12) Patent Application Publication
(10) Pub. No.: US 2025/0181953 A1
(43) Pub. Date: Jun. 5, 2025

(54) HETEROGENEOUS MODULAR ARCHITECTURE FOR QUANTUM COMPUTING

(71) Applicant: International Business Machines Corporation, Armonk, NY (US)

(72) Inventors: Andrew W. Cross, Yorktown Heights, NY (US); Shawn Anthony Hall, Pleasantville, NY (US); Patrick Julian Tassilo Rall, Boston, MA (US); Theodore James Yoder, Mohegan Lake, NY (US)

(21) Appl. No.: 18/527,305

(22) Filed: Dec. 3, 2023

(51) Int. Cl. G06N 10/40

(52) U.S. Cl. CPC G06N 10/40

(57) ABSTRACT

According to an embodiment of the present invention, a system may include a quantum memory module, a magic state preparation module, and a quantum computation module. The quantum computation module is coupled to either the quantum memory module or the quantum magic state preparation module using an 1-coupler. This may enable optimization of the hardware to more efficiently perform quantum computations. According to another embodiment of the present invention, a modular system may include a plurality of quantum systems, where the quantum systems are connected using 1-couplers according to a tree diagram. This may enable optimization of the hardware to more efficiently perform quantum computations.

### BACKGROUND

The present invention relates to Quantum Computing, and more specifically, to modular architectures for quantum computing systems.

### SUMMARY

According to an embodiment of the present invention, a system may include a quantum memory module, a magic state preparation module, and a quantum computation module. The quantum computation module is coupled to either the quantum memory module or the quantum magic state preparation module using an 1-coupler. This may enable optimization of the hardware to more efficiently perform quantum computations.

A further embodiment of the above system may include an 1-coupler extending between unit cells of a modular cryostat. This may enable further flexibility in hardware layout.

A further embodiment of the above system may include the quantum memory module having a memory codeblock, a large probe ancilla code block, and a surface code block.

A further embodiment of the above system may include the magic state preparation module comprises at least one surface code blocks.

A further embodiment of the above system may include the quantum computation code block comprises at least two or more surface code block.

A further embodiment of the above system may include each code block is located on a chip.

According to an embodiment of the present invention, a modular system may include a plurality of quantum systems, where the quantum systems are connected using 1-couplers according to a tree diagram. This may enable optimization of the hardware to more efficiently perform quantum computations.

A further embodiment of the above modular system may include a physical arrangement of the tree diagram is in an H-tree arrangement.

A further embodiment of the above modular system may include a physical arrangement of the tree diagram is a linear arrangement.

A further embodiment of the above modular system may include a first portion of a physical arrangement of the tree diagram uses a linear arrangement, and wherein a second portion of a physical arrangement of the tree diagram uses an H-tree arrangement.

A further embodiment of the above modular system may include redundant couplers. This may provide a more fault tolerant system.

A further embodiment of the above modular system may include redundant couplers connected to vertical unit cells. This may provide a more fault tolerant system.

A further embodiment of the above modular system may include redundant couplers between leaves of the tree diagram. This may provide a more fault tolerant system.

A further embodiment of the above modular system may include redundant couplers are connected to vertical unit cells and between leaves of the tree diagram. This may provide a more fault tolerant system.

### BRIEF DESCRIPTION OF THE DRAWINGS

FIG. 1 depicts representative elements of a modular quantum computing system, according to an example embodiment;

FIG. 2 depicts a modular quantum computing system, according to an example embodiment;

FIG. 3 depicts a first module type of a modular quantum computing system, according to an example embodiment;

FIG. 4 depicts a second module type of a modular quantum computing system, according to an example embodiment;

FIG. 5 depicts a third module type of a modular quantum computing system, according to an example embodiment;

FIG. 6 depicts a fourth module type of a modular quantum computing system, according to an example embodiment;

FIG. 7 depicts a tree-diagram for connecting modules of a modular quantum computing system, according to an example embodiment;

FIG. 8 depicts a layout of modules according to the tree-diagram using an H-tree arrangement for a modular quantum computing system, according to an example embodiment;

FIG. 9 depicts a layout of modules according to the tree-diagram using a linear arrangement for a modular quantum computing system, according to an example embodiment;

FIG. 10 depicts a vertically-redundant tree-diagram for connecting cells of a modular quantum computing system, according to an example embodiment;

FIG. 11 depicts a modular coupling scheme for a Vertically-redundant tree-diagram for connecting cells of a modular quantum computing system, according to an example embodiment;

FIG. 12 depicts a leaf redundant tree-diagram for connecting cells of a modular quantum computing system, according to an example embodiment;

FIG. 13 depicts a modular coupling scheme for a leaf redundant tree-diagram for connecting two module cells of a modular quantum computing system, according to an example embodiment; and

FIG. 14 depicts a modular coupling scheme for a leaf redundant tree-diagram for connecting single module cells of a modular quantum computing system, according to an example embodiment.

### DETAILED DESCRIPTION

As Quantum Computing hardware becomes more robust, practical implementation of theoretical constructs represents another step to achieving utility in large quantum systems. The combination of advances in error correcting codes, magic state distillation, and other surface codes and technologies for fault tolerant quantum computing create the possibility of error-corrected quantum systems with universal quantum gates. However, this presents challenges of integrating these disparate elements based on design constraints of the elements and practical physical considerations.

To aid in the discussion, the following are definitions for use throughout.

A “code block” is an arrangement of qubits and other devices to perform a specific function (e.g., computation, data storage, data transfer) based on different types of error correcting code.

A “chip” is a substrate and interposer containing circuitry for performing operations. Routing of couplings can be done on a surface of the substrate, through the interposer, or using a multi-level wiring component, or combinations thereof to achieve specific connectivity required for operation of a code block. A chip may contain a single code block, or multiple code blocks, depending on the size and requirements of the code block.

A “module” is one or more code blocks that are arranged to perform specific tasks. A module may be one or more chips, based on the requirements of the code block. For simplicity, a depiction of a code block located within a module can represent either multiple chips connected by m-couplers, a single chip with multiple modules located within it, or combinations thereof.

A “unit cell” may include multiple modules. In one example, a unit cell may be a modular cryostat capable of housing one or more modules.

A “c-coupler” is a non-local (i.e., not nearest-neighbor) coupler between qubits on the same chip. Such coupling may be accomplished by routing coupling on a different level of the chip from the qubits using, for example, bump-bonded interposers or multi-level wiring.

An “m-coupler” is a coupling from one chip to an adjacent chip within a module.

An “1-coupler” is a long-range coupler to link modules. An 1-coupler is noisier than a c-coupler or m-coupler. L-couplers may be on the order of meters in length.

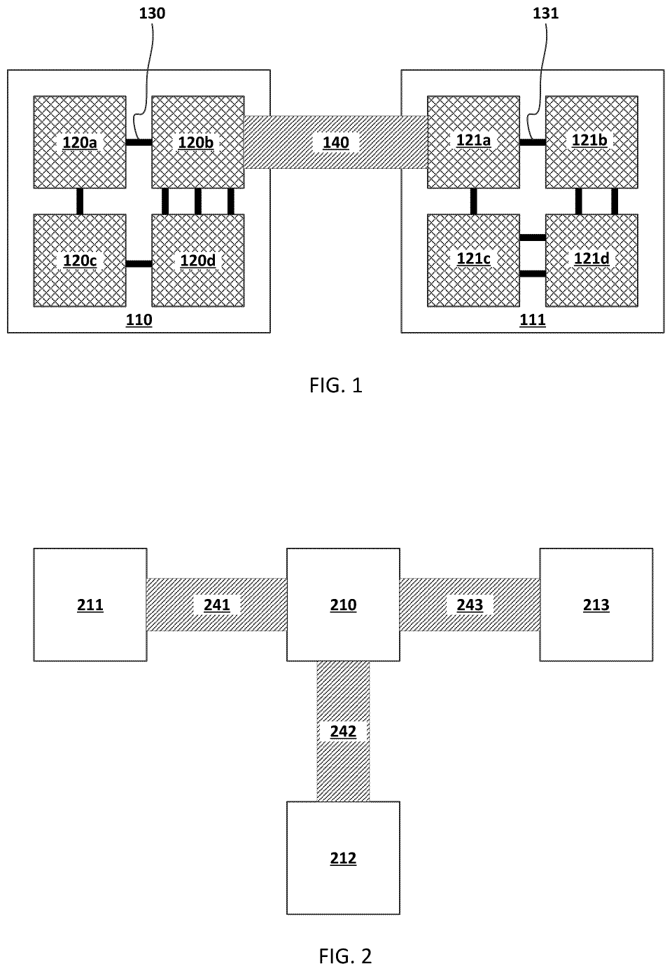

Referring to FIG. 1, representative elements of a modular quantum computing system are depicted. A first module 110 and a second module 111 are depicted as coupled by an 1-coupler 140. The first module 110 contains a first code block 120a located on a first chip, a second code block 120b located on a second chip, a third code block 120c located on a third chip, and a fourth code block 120d located on a fourth chip. Each chip is connected to adjacent chips through at least one m-coupler 130. The second module 111 contains a fifth code block 121a located on a fifth chip, a sixth code block 121b located on a sixth chip, a seventh code block 121c located on a seventh chip, and an eighth code block 121d located on a eighth chip. Each chip is connected to adjacent chips through at least one m-coupler 131. Placement of code blocks on a module may be chosen based on the connectivity required for performing logical operations or a logical algorithm on the encoded qubits. This may include capabilities of particular quantum error correction codes based on their logical gates, requirements for logical measurements and/or fault tolerant transmission of data between different code blocks.

Referring to FIG. 2 an arrangement of modules for a modular quantum computing system is depicted. In the example arrangement, computing module 210 may be connected to a first memory module 212 through a first 1-coupler 242, a second memory module 213 through a second 1-coupler 243, and a magic state distillation module 211 through a third 1-coupler 241. Such an arrangement may enable transfer of quantum states from either first memory 212 or second memory 213 to the computing module 211, where computing module 211 may use magic states created in the magic state module to perform a set of quantum gates on the states that were stored in either memory. In such an architecture, the intermittent nature of transferring magic states or quantum states from memory to the computing module 211 in order to perform quantum computations may enable these modules to be distanced apart from the computing module by an 1-coupler, as the increased error rate by the coupler can be offset by a decreased transfer rate. Such modularity and system design may enable larger and more efficient layouts within the computing module 211, as code blocks can be specialized for specific tasks and computations which may allow for optimization of computations based on the architecture of the hardware, while adhering to special considerations within the module. In an example embodiment, each module may be located in a separate payload of a cryostat. In other embodiments, modules may be combined as a unit cell, and each unit cell may be a separate payload of a cryostat.

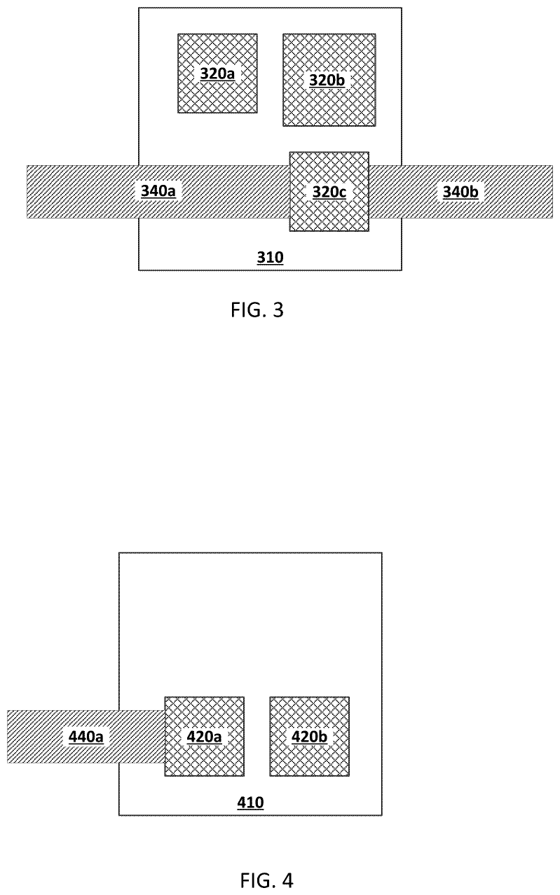

Referring to FIG. 3 an example memory module 310 of a modular quantum computing system is depicted. In this example, code block 320a may be an LDPC memory code block, which contains an architecture for error corrected quantum memory. Code block 320b may be a large probe ancilla, which is structured to perform quantum operations on individually addressed logical qubits in the code block 320a. and fault tolerantly transfer information between the LDPC code block 320a and the surface code block 320c. Code block 320c may be a surface code code block, attached to a first 1-coupler 340a and a second 1-coupler 340b, which may be capable of enabling the transfer of quantum states along the 1-coupler.

Referring to FIG. 4 depicts an example magic state distillation module 410 of a modular quantum computing system. In the example embodiment, a first surface code 420a and second surface code 420b may be designed to prepare different magic status, such as |T> states, |CZ> states, |CCZ> states, etc. In this embodiment, the multiple code blocks are depicted and located on separate chips due to the limitations in the number of qubits per chip, and the number of qubits required to perform magic state distillation.

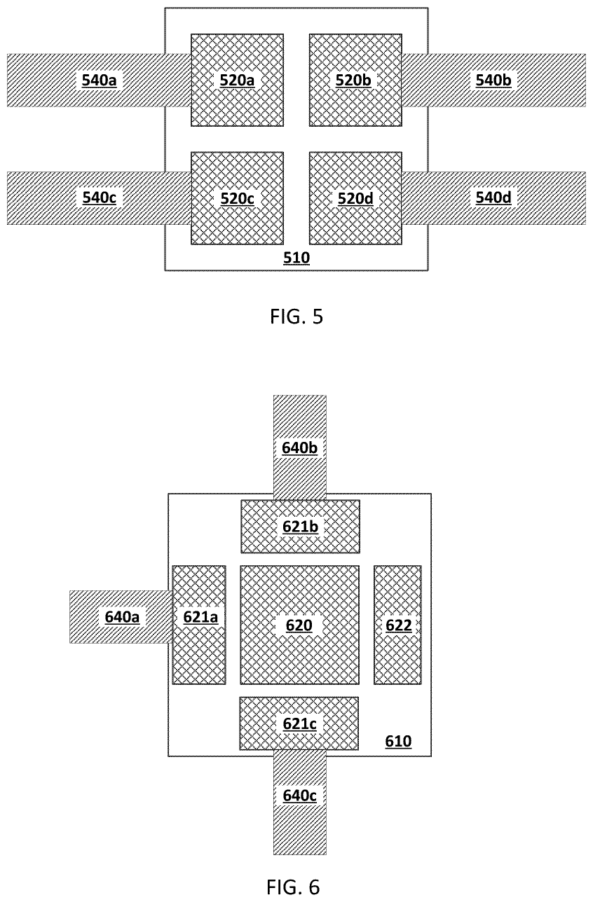

Referring to FIG. 5 a computation module 510 of a modular quantum computing system is depicted. The computation module 510 may contain 4 surface code blocks 520a, 520b, 520c, and 520d. Each of these surface code blocks may be coupled to each other, using either a c-coupler or m-coupler, and coupled to other modules through the respective 1-couplers 540a, 540b, 540c, and 540d. In one embodiment, the surface code may be a [[121,1,11]] surface code to facilitate fast Clifford gates between pairs of qubits. This efficient use of coupling may enable quantum computations to be performed in an environment with high speed and low error couplings amongst the qubits in an attempt to optimize and improve the ability to perform quantum computations.

Referring to FIG. 6, an example LDPC code computing module 610 is depicted. In some embodiments, computing module 610 may act a memory module. In this example embodiment, a local ancilla code block 622 is coupled to an LDPC code block 620. The local ancilla code block 622 facilitates Clifford operations and/or state injection into the LDPC code block 622. The LDPC code block 622 is coupled to three different coupling ancilla code blocks 621a, 621b, and 621c which are capable of transferring quantum states along their respective 1-couplers 640a, 640b, and 640c. The ancilla code blocks 621a, 621b, and 621c may contain architectures that connect LDPC modules directly to one another, without an intervening surface code. Such ancilla codes may include subgraphs of the LDPC Tanner graph that are chosen to improve tolerance to L-coupler noise.

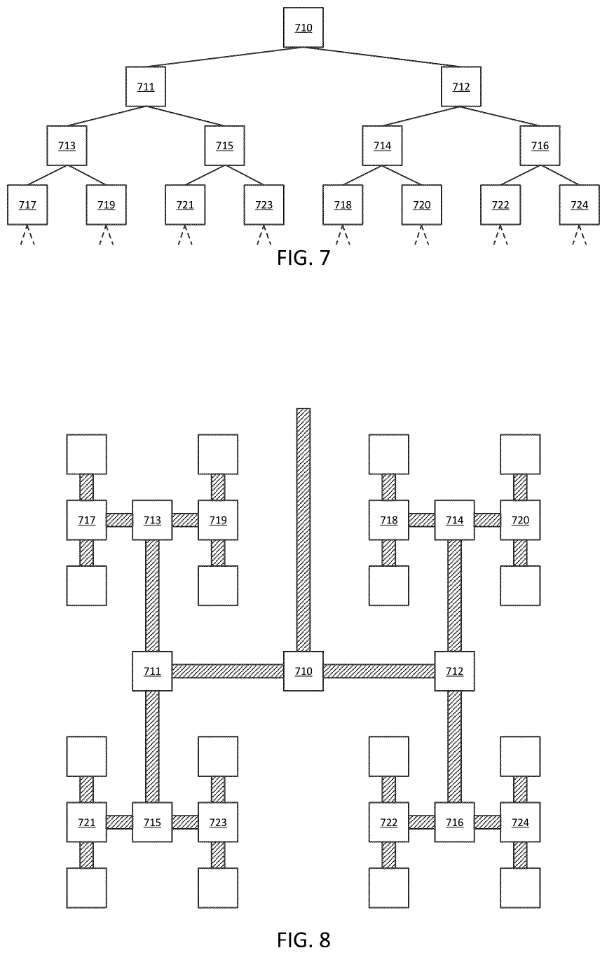

Referring to FIG. 7 depicts a tree-diagram for connecting unit cells, containing modules, of a modular quantum computing system in order to reduce the number of couplings between all unit cells of the system. In this system, unit cells 710-724 may be referred to as parents of the unit cells connected them in the diagram, and children to unit cells connected above them in the diagram. For example, unit cell 715 is a parent to unit cells 721 and 723, and a child to unit cell 711. In this arrangement, unit cells are at most 2*log₂(n_{unit cells}+1)−2 from any other unit cell in the arrangement, where n_{unit cells} is the total number of unit cells.

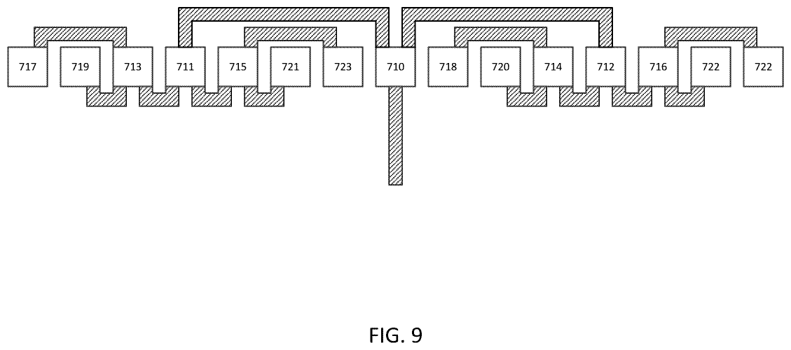

Referring to FIG. 8 depicts an example layout of unit cells according to the tree-diagram using an H-tree arrangement for a modular quantum computing system. For illustrative clarity, the numbering refers to the location in the tree diagram of FIG. 7. In this example embodiment, the physical arrangement of the H-tree minimizes the total distance of 1-couplers needed to couple the entire system. This may enable more efficient transfers between unit cells in the system due to the reduced distances and create a smaller overall footprint as the density (unit cells/area) increase with the then increase in tree levels.

Referring to FIG. 9, depicts an example layout of unit cells according to the tree-diagram using a linear arrangement for a modular quantum computing system. For illustrative clarity, the numbering refers to the location in the tree diagram of FIG. 7. Such linear arrangements may enable more than three unit cells (e.g., 7, 15) to be arranged in a row, which may enable the use of types of modular cryostats with increased serviceability due to their linear arrangement. In such an arrangement, max coupler length is (n_{unit cells}+1)/4.

Referring to FIGS. 8 and 9, while an exemplary H-tree and exemplary linear arrangement were presented, it should be understood that a hybrid approach may be taken as well, here linear arrangements may be connected using H-tree connectors.

Referring to FIG. 10 depicts an example vertically-redundant tree-diagram for connecting cells of a modular quantum computing system. The tree-diagram is an example routing of redundant cabling from child to parent (or orders above) to create an alternative pathway to transmit quantum information in an instance where an 1-coupler in the path fails. In some instances, there are two L-couplers from a child to a parent, such as between 713 and 717. In some instances, an L-coupler is introduced to bypass the parent, such as in 711 and 719. Additionally, to create fault tolerance to any single L-coupler failure, another quantum unit cell 705 is introduced to provide a space for a redundant connection to quantum unit cell 724.

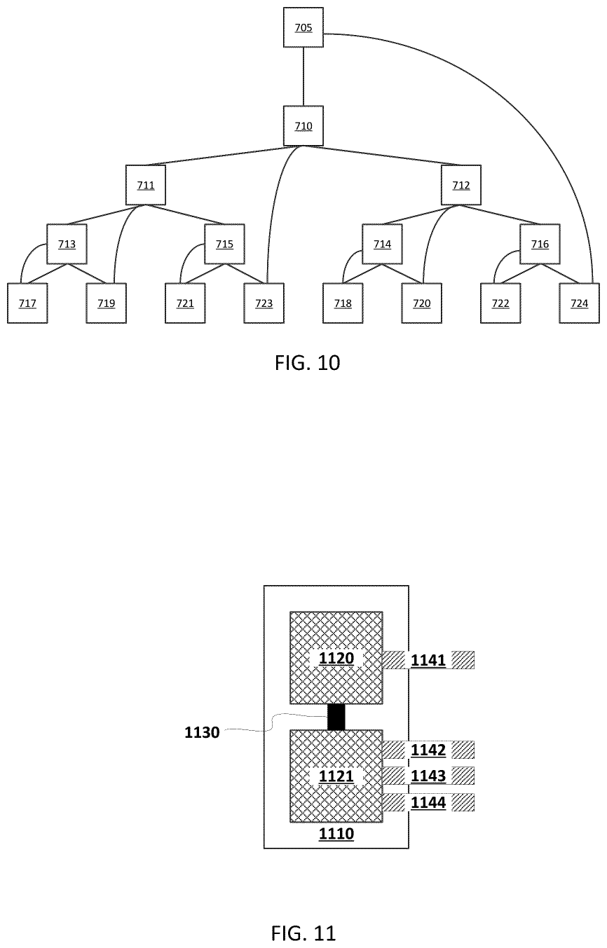

Referring to FIG. 11 depicts a coupling scheme of a unit cell 1110 in a Vertically-redundant tree-diagram for connecting unit cells of a modular quantum computing system. In the example unit cell 1110, a first module 1120 and a second module are coupled using an m-coupler 1130. The unit cell 1110 has 4 L-couplers 1141, 1142, 1143, and 1144 that can be coupled in any combination to either the first module 1120 and second module 1121, but the example embodiment is depicted as having one 1-coupler 1141 connected to the first module 1120, and three 1-couplers 1142, 1143, and 1144 coupled to the second module 1121. As the first module 1120 and second module 1121 are coupled using m-coupler 1130, this enable transfer of information to second module 1121 using 1-coupler 1141 through the first module 1120 and m-coupler 1130. In this example, as all unit cells require 3 or 4 1-couplers, the coupling scheme would be sufficient. For example, the routing based on the tree connections depicted in FIG. 7 may be done through 1-couplers 1142, 1143, and 1144, while redundant routing may be accomplished using 1-coupler 1141, however different schemes may be contemplated.

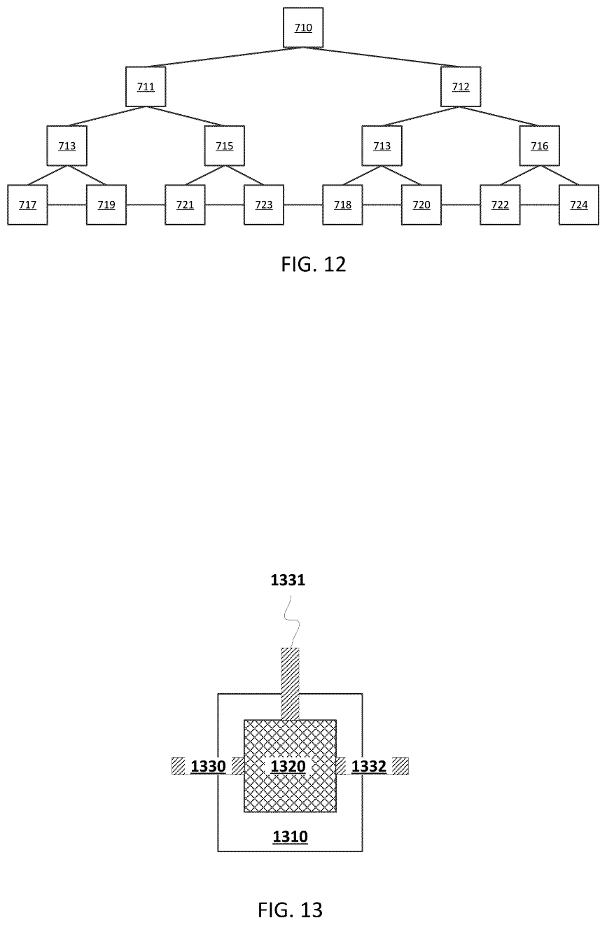

Referring to FIG. 12, an example leaf redundant tree-diagram for connecting unit cells of a modular quantum computing system is depicted. In this arrangement, the unit cells at the bottom of the tree diagram (i.e., leaves) may all be connected, thereby creating a redundant path between any unit cells of the system.

Referring to FIG. 1313, an example unit cell of a modular coupling scheme for a leaf redundant tree-diagram is depicted. In the example unit cell 1310, module 1320 has three 1-couplers, 1330, 1331, and 1332. When the coupler is used in an intermediate cell (e.g., unit cell 715), this enables a connection to a parent unit cell 711 through 1-coupler 1331, and coupling to child unit cells 721 and 723 through 1-couplers 1330 and 1332. When the coupler is used for a leaf unit cell (e.g., unit cell 721) this enables a connection to a parent unit cell 715 through 1-coupler 1331, and coupling to adjacent leaf unit cells 719 and 723 through 1-couplers 1330 and 1332.

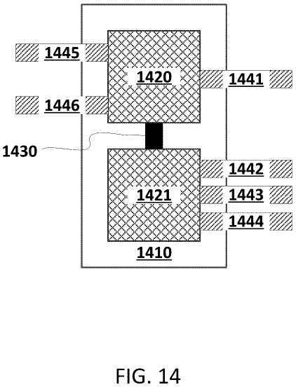

Referring to FIG. 14, an example unit cell 1410 of a modular coupling scheme for combining a leaf redundant tree-diagram with a vertically redundant tree diagram is depicted. In this embodiment, the 1-coupler 1441 may form similar unit cell couplings as 1-coupler 1331 and 1-coupler 114. L-couplers 1445 and 1446 may form similar unit cell couplings as 1-coupler 1330 and 1332, respectively. L-couplers 1442, 1443, and 1444 may form similar unit cell couplings as L-couplers 1142, 1143, and 1144, respectively. This may aid in the redundancy of the overall system.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a quantum memory module;
a magic state preparation module; and
a quantum computation module, wherein the quantum computation module is coupled to either the quantum memory module or the quantum magic state preparation module using an 1-coupler.

2. The system of claim 1 wherein 1-coupler extends between unit cells of a modular cryostat.

3. The system of claim 1, wherein the quantum memory module comprises a memory codeblock, a large probe ancilla code block, and a surface code block.

4. The system of claim 1, wherein the magic state preparation module comprises at least one surface code blocks.

5. The system of claim 1, wherein the quantum computation code block comprises at least two or more surface code block.

6. The system of claim 5, wherein each code block is located on a chip.

7. A system comprising:
a plurality of quantum systems, wherein the plurality of quantum systems are connected using 1-couplers according to a tree diagram.

8. The system of claim 7, wherein a physical arrangement of the tree diagram is in an H-tree arrangement.

9. The system of claim 7, wherein a physical arrangement of the tree diagram is a linear arrangement.

10. The system of claim 7, wherein a first portion of a physical arrangement of the tree diagram uses a linear arrangement, and wherein a second portion of a physical arrangement of the tree diagram uses an H-tree arrangement.

11. The system of claim 7 further comprising redundant couplers.

12. The system of claim 11, wherein the redundant couplers are connected to vertical unit cells.

13. The system of claim 11, wherein the redundant couplers are between leaves of the tree diagram.

14. The system of claim 11, wherein the redundant couplers are connected to vertical unit cells and between leaves of the tree diagram.
